(19) United States
(12) Patent Application Publication
(10) Pub. No.: US 2013/0246903 A1
(43) Pub. Date: Sep. 19, 2013

(54) SYSTEM AND METHODS FOR STRUCTURED EVALUATION, ANALYSIS, AND RETRIEVAL OF DOCUMENT CONTENTS

(71) Applicant: Keith Douglas Mukai, Des Plaines, IL (US)

(72) Inventor: Keith Douglas Mukai, Des Plaines, IL (US)

(21) Appl. No.: 13/607,696

(22) Filed: Sep. 8, 2012

Related U.S. Application Data
(60) Provisional application No. 61/533,224, filed on Sep. 11, 2011.

(51) Int. Cl. G06F 17/21

(52) U.S. Cl. CPC G06F 17/218
USPC 715/234

(57) ABSTRACT

The present invention relates to a system and methods for reviewers to evaluate digital document contents in a structured manner that facilitates document archiving and retrieval as well as aggregate document analysis. These systems and methods have many applications, including use for education, training, intelligent document indexing and archiving, and more.

### CROSS REFERENCE

The present application claims priority to the Provisional Application, U.S. Patent Application No. 61/533,224, filed on Sep. 11, 2011, by the present applicant.

### FIELD OF THE INVENTION

The present invention relates to a system and method of evaluating, analyzing, and reviewing electronic documents and further relating to a system and method of collecting, storing and analyzing the evaluations of multiple electronic documents.

### BACKGROUND OF THE INVENTION

Educators, attorneys, physicians, and numerous other professionals in a wide array of occupations review and generate an enormous quantity of text-based documents. Increasingly these documents are being delivered and consumed in digital formats, quickly replacing printed pages and books. These professionals rarely read a document simply for the sake of reading it; generally there is an evaluation component involved: a teacher must evaluate a student's essay, an attorney must evaluate a judge's ruling to see if the precedent is applicable to the current case.

As the professional becomes inundated with documents, it becomes more and more difficult to keep track of those evaluations—which student had the really strong thesis? Which case had the promising precedent? Keeping track of those evaluations and making them readily available to the professional is an increasingly important part of document management in the digital era.

In other contexts, especially education, aggregate data about those evaluations can be enormously valuable as they can reveal common weaknesses within a group of writers as well individual and group progression over time. But as the quantity and complexity of those evaluations grow, the more difficult it is to manage, analyze, and retrieve those evaluations in aggregate.

### DESCRIPTION OF THE DRAWINGS

FIG. 1 is a flowchart illustrating steps of the method of the present invention.

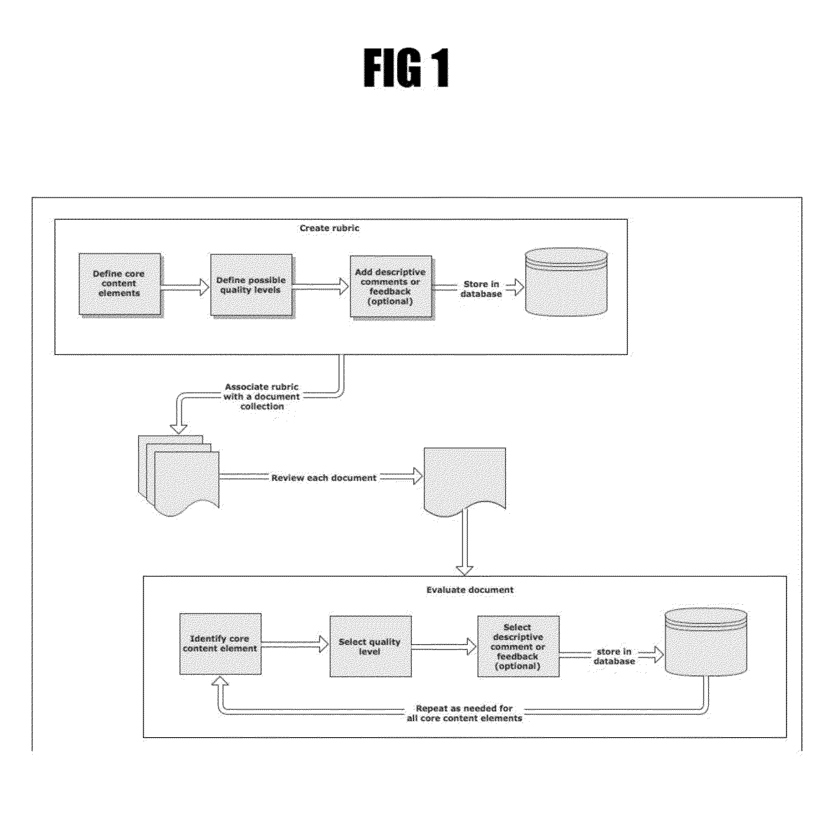

FIG. 2 shows an exemplary core content element specification and possible quality level specification screen in some embodiments of the present invention.

FIG. 3 shows an exemplary descriptive and/or feedback comment grid specification screen in some embodiments of the present invention.

FIG. 4 shows an exemplary document atomization and evaluation application in some embodiments of the present invention.

FIG. 5 shows an exemplary core content element atomization screen.

FIG. 6 shows an exemplary core content element evaluation screen.

FIG. 7 shows an exemplary reporting screen of a document's atomized core content elements and their associated quality level evaluations.

FIG. 8 shows an exemplary reporting screen of the aggregate quality level results for a specific core content element across an entire document collection and further illustrates access to each associated document excerpt organized by quality level.

FIG. 9 shows an exemplary reporting screen of a document collection analyzed in aggregate, listing the core content elements and the distribution of quality levels for each core content element (class performance on a single assignment).

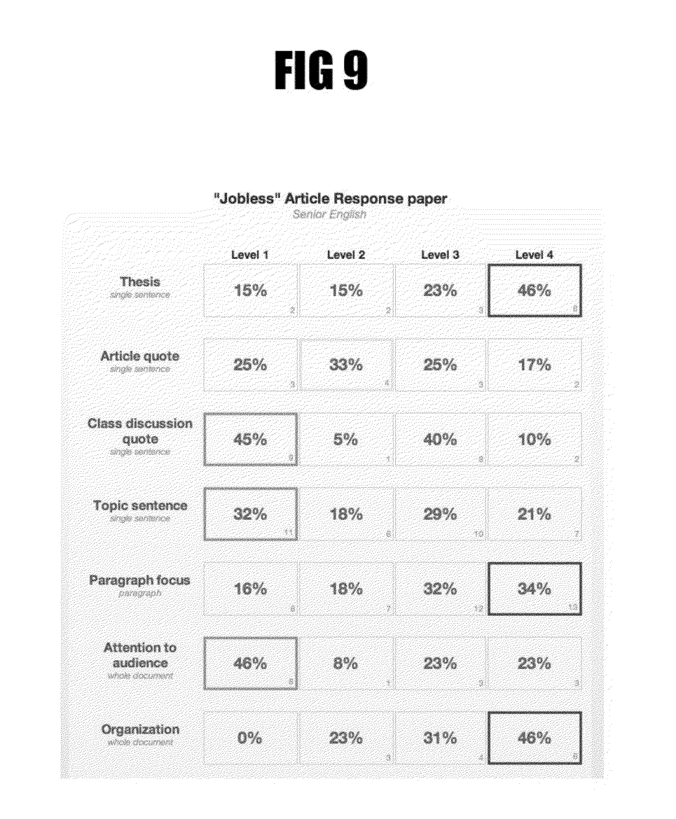

FIG. 10 shows an exemplary reporting screen of a document collection analyzed as a progression over time (an individual student's progression over multiple assignments).

FIG. 11 shows an exemplary reporting screen of multiple document collections analyzed in aggregate and as a progression over time (class progression over multiple assignments).

FIG. 12 illustrates the steps of the present invention of the review and evaluation stages of the present invention.

FIG. 13 illustrates the steps of retrieving the original document and evaluation that has been stored in the database.

FIG. 14 shows an exemplary information flow during the aggregate analysis of a core content element across an entire document collection including the following steps: data is retrieved from the database; each core content element in the rubric is retrieved and/or calculated; the distribution of quality levels for each core content element is retrieved and/or calculated.

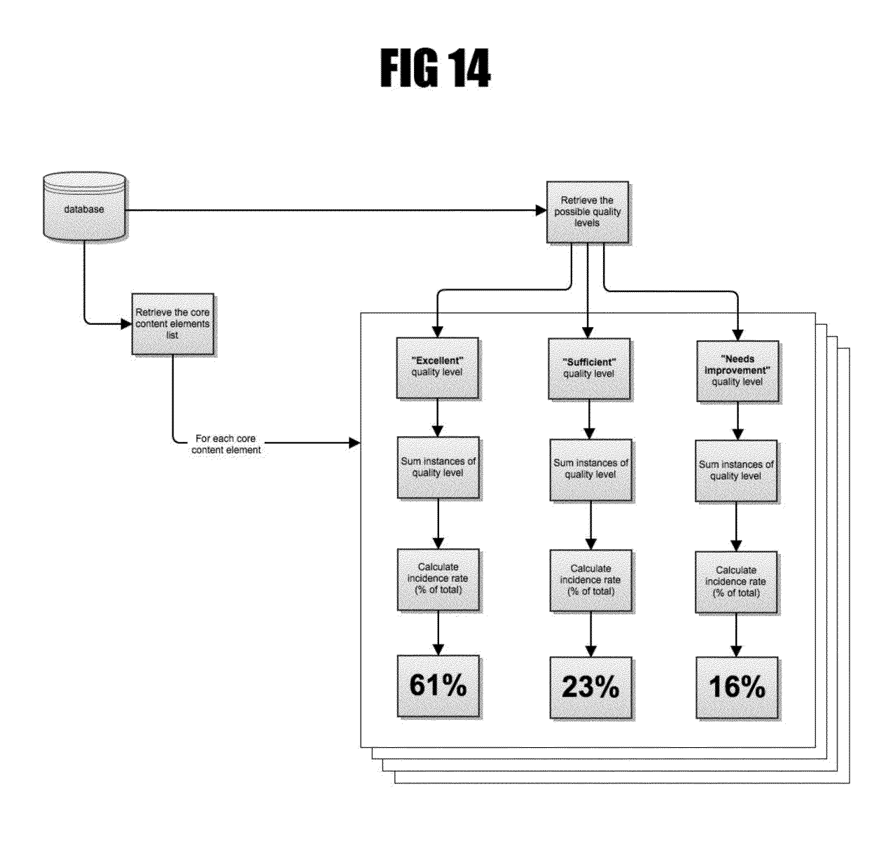

### SUMMARY OF THE INVENTION

The present invention provides a system and methods for structured review and evaluation of digital documents in such a way that facilitates the organization and retrieval of the evaluations, the specific document excerpt that the evaluation applies to, and any comments that the user may have given for a specified selection of the document. Such systems and methods find use for education, advanced document archiving, and any other application that requires analysis and retrieval of document evaluations and content.

A typical document has very few meaningful quantifiable characteristics; page length and word count are easily calculated, but they cannot capture the essence and value of the content. And yet modern professionals have a great need to make document contents quantifiable in order to leverage the organizational power of computer databases. The present invention provides systems and methods for making document contents quantifiable. But this quantified data is not based on algorithmic text analysis or any automated process of the sort. Rather, the quantified content captures the reviewer's opinions and evaluations of the content and stores it all in a database for later analysis and retrieval.

The present invention provides users with the ability to provide structured evaluations to the content of a document and store such evaluations to be retrieved by the reviewer or other users. The present invention is comprised of a processor or software configured to receive documents over an electronic communication network to allow reviewers to provide structured evaluations with respect to specific document excerpts to generate an evaluated version of the document and then display such evaluations and/or the evaluated version of the document on the World Wide Web, via email, or other electronic presentation and distribution mediums.

The present invention provides for a system that allows a user to define the “core content elements” of a given electronic document; evaluate such core content elements, and then provides for the organization, retrieval, and quantifiable analysis of such evaluations and the specific document excerpts associated with said evaluations. The method of the present invention includes the following steps: creating a rubric which is stored in a database; associating the created rubric with a document collection; reviewing each document and storing such evaluation within a database. The rubric may be created by defining the core content elements; defining possible quality levels; adding descriptive comments or feedback if necessary and then storing the above in a database. Once the user has reviewed each document, the system provides the user with the ability to evaluate each document by identifying the core element of each document, selecting the appropriate quality level, selecting descriptive comments or feedback if necessary and then storing such evaluation in a database.

In the present invention, the user begins by defining the “core content elements” that she is looking for in each document from a particular collection. The core content elements are specific components of a document that are to be evaluated by the reviewer. In education, the document collection would consist of the essays students produced for a particular assignment. The core content elements would come from the assignment's list of expectations: have a strong thesis, use compelling evidence, transition between ideas, etc.

Similarly in a legal context, the document collection might consist of a set of judges' rulings on a particular point of law. The core content elements being considered might be: which precedents were cited, which legal statutes were referenced, the judge's final ruling, etc.

The user then defines the “possible quality levels” that could be applied to each core content element. A teacher might specify “Excellent”, “Sufficient”, “Needs Improvement”, or “Missing or Not Acceptable” as her possible quality levels for the current assignment. The attorney might specify “Highly relevant”, “Possibly useful”, “Must avoid”, or “Irrelevant”.

Combining a core content element with a possible quality level produces a quantifiable piece of data that captures the reviewer's evaluation: the “Thesis” is “Excellent”; the “Judge's ruling” is “Possibly useful”.

One benefit of the present invention is that the core content elements and the possible quality levels are specified by the reviewer and are customized to the reviewer's particular purpose. For example, the teacher wants to grade essays and provide feedback to each student; the attorney wants to review legal rulings to build a strategy for his current case. The present invention, therefore, can be applied to vastly different types of documents and purposes.

The next step for the reviewer is to “atomize” the document it into its constituent parts or its core content elements. For example, the teacher reads an essay and identifies the sentence that is the student's thesis. The reviewer “tags” or associates that document excerpt with the “Thesis” core content element.

Once tagged, the teacher then selects the appropriate quality level for that thesis from the possible quality levels selected by the reviewer for the creation of the rubric. The atomized document excerpt, its associated core content element, and the teacher's quality level assessment are all stored in the database.

After evaluating all documents from the collection in this manner, the system provides the reviewer with the ability to organize and retrieve all such information and data from the database. In the education example, the system can query for things such as:
What was Jimmy's thesis and how good was it? (retrieve content and evaluation)
How many students had “Excellent” evidence? (aggregate analysis of evaluations)
Retrieve 10 random examples of transitions that “Need Improvement”. (retrieval based on evaluated quality level)

And if the same core content elements and same possible quality levels are used for multiple document collections, data can be analyzed over time:
Is Jimmy improving at writing a thesis? (individual progression)
Is the class improving at their use of evidence (aggregate progression)
Is Jimmy's progression with evidence keeping pace with his classmates'? (individual vs aggregate progression)

Benefits of the systems and methods of the present invention include, but are not limited to: 1) standardization of document evaluation methods; 2) enables a wide array of quantitative analysis of documents which are, inherently, non-quantitative entities; 3) faster document evaluation; 4) enable storage and retrieval of evaluations which are normally lost or forgotten.

### DEFINITIONS

To facilitate understanding of the present invention, a number of terms and phrases are defined below:

The term “reviewer” is used to refer to the person who will be reading and evaluating a document or documents through the current invention's systems and methods.

The term “atomization” is used to refer to the process the reviewer undertakes to break a document down to its constituent parts or core content elements. The reviewer identifies a specific core content element in the text and associates the corresponding text passage with the appropriate core content element.

The term “evaluate” is used generally to refer to the decision-making process the reviewer undertakes when reviewing a document; and specifically, when a reviewer assigns a particular quality level to a particular core content element.

The phrase “core content elements” is used to refer to the specific components of a document that are to be evaluated by the reviewer.

The phrase “quality levels” is used to refer to the spectrum of possible evaluations that have been pre-defined for a particular rubric. When each core content element is evaluated, the reviewer selects the appropriate quality level that s/he deems appropriate for that particular core content element.

The term “rubric” is used to refer to the combination of core content elements, the possible quality levels, and an optional collection of comments. A single rubric is applied to a collection of similar documents to enable the structured evaluation method made possibly by the present invention.

The term “comment” is used generally to refer to electronic or digital response in any form of media including text, audio file, video file, and/or piece of text, that is provided by the reviewer in response to a document; and specifically, as optional text that is associated with a specific quality level for a specific core content element. Comments may describe exemplars of typical core content elements for that quality level, may consist of feedback or suggestions for improvements for core content elements at that quality level, and other possibilities.

The phrase “structured evaluation” is used to refer to the process of reviewing and evaluating a document using the organized and pre-defined method made possible by the present invention.

The phrase “structured comments” is used to refer to the optional comments that can be added to a rubric using the systems and methods described in the current invention. Such comments are considered “structured” because they are associated with a specific core content element at a specific quality level which allows for more advanced content retrieval and evaluation data analysis than would otherwise be possible.

The phrase “document” is used to refer to any electronic source material that the reviewer will be evaluating, including text documents, slideshow presentations, websites, and other such reviewable electronic content.

The phrase “document collection” is used to refer to the group of similar documents that will be evaluated by the reviewer under the same rubric.

The phrase “similar documents” is used to refer to documents that have a similar format, purpose, or other coordinating characteristics that make direct comparisons between documents possible.

The phrase “document archiving” is used generally to refer to the storage of a large quantity of documents, a subset of which will be retrieved at a later date as the need arises; and specifically, as an electronic document storage and retrieval system that facilitates retrieval of the desired documents by means of a complex data management system, such as the one made possible by the current invention.

The phrase “document excerpt” is used to refer to a specific selection range of a document. A document excerpt may consist of a single sentence, a series of continuous sentences, a paragraph, or other selection ranges which may also include embedded images, multimedia, or other non-text elements included in the document depending on the needs of the application.

### DETAILED DESCRIPTION OF THE INVENTION

The present invention provides systems and methods for reviewers to evaluate document contents in a structured manner that facilitates document archiving and retrieval as well as aggregate document analysis. For example, the present invention provides systems and methods for teachers to evaluate students' essays while simultaneously leveraging the abilities a computer database.

The system and methods of the present invention are used by a reviewer who is evaluating a collection of similar digital documents against a specified criteria. Such uses include any that involve evaluating a collection of similar documents, including, but not limited to, a teacher grading a class' essays, an attorney reviewing a series of judges' rulings, and many others.

A preferred embodiment of the invention is provided in the Figures. The example shown in the Figures illustrates the invention within the context of an essay-grading Website for teachers. Descriptions of features and processes typical of standard Websites that are not unique to this invention, such as registration and login, have been omitted for brevity. Skilled artisans will understand that this embodiment can be accessed by a wide variety of Web-enabled computers and portable devices, including, but not limited to, desktop computers, laptops, netbooks, smart phones, and tablets.

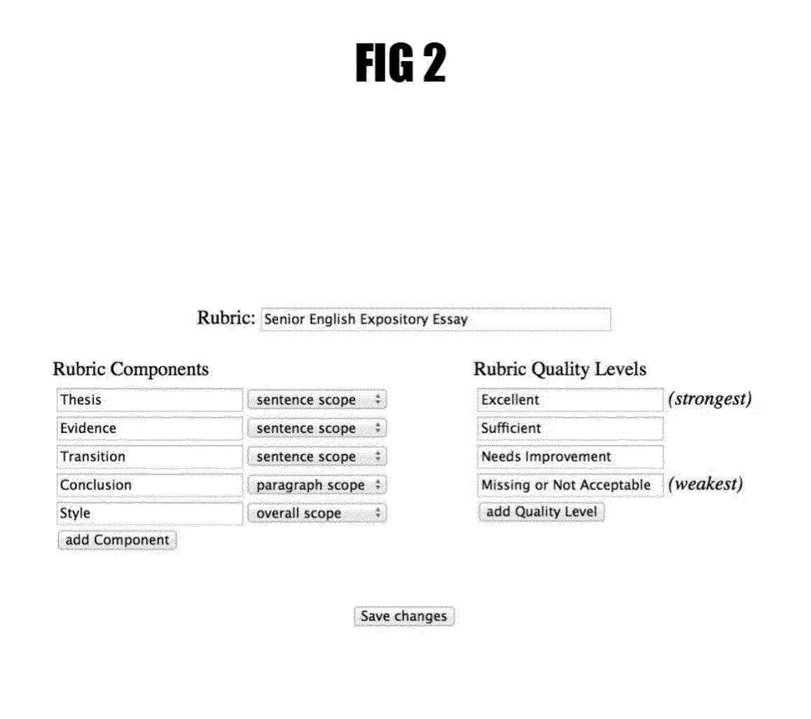

As shown in FIG. 2, the structured evaluation process begins with the user creating or modifying a rubric that will be applied to a particular essay assignment. The user in the present invention (the “reviewer”) is most likely an educator such as a teacher and gives the rubric a title and then identifies the core content elements that are relevant to the assignment. In this example, core content elements can be configured to apply to individual sentences in the documents, whole paragraphs of the document, or the document as a whole. Additional core content elements can be added as needed.

The reviewer then determines the rubric's possible quality levels. The reviewer specifies the labels for each quality level with the highest quality level at the top of the list and the lowest quality level at the bottom. The reviewer may add quality levels as needed.

When the reviewer is satisfied with the rubric, the reviewer saves the rubric to the system's database.

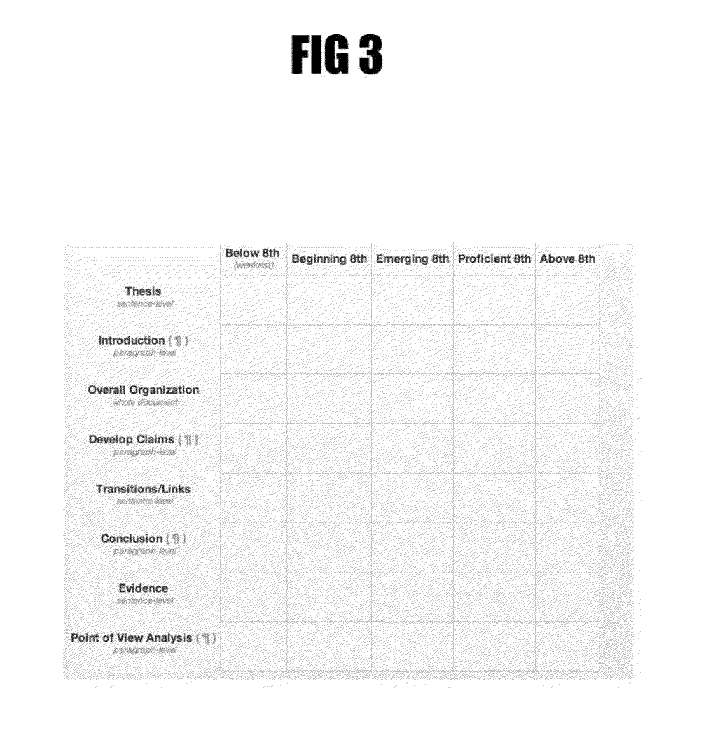

As shown in FIG. 3, the core content elements and the possible quality levels create a grid where each possible combination of a core content element with a possible quality level creates a unique x, y position in the grid. The reviewer may optionally add descriptive comments or feedback in each grid position.

The reviewer then configures an essay assignment to use the desired rubric and the modification is saved to the system's database.

The system provides the reviewer with the ability to upload digital documents associated with a particular assignment. In some embodiments the reviewer uploads the documents, in others the document authors upload their own documents. Electronic documents may be added or uploaded to the system using any conventional method and any such methods are ancillary to the invention described here.

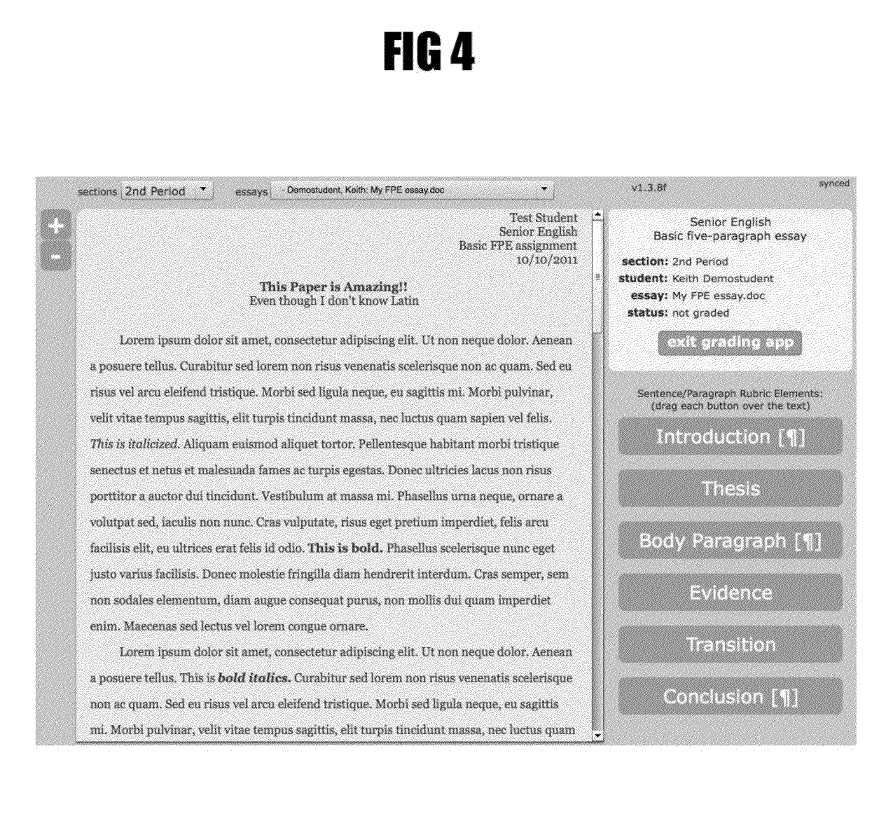

The next step is the evaluation stage. As shown in FIG. 4, when the reviewer accesses a particular document, the system displays the document, the assignment the current document is associated with, the rubric associated with the assignment, the student who wrote the essay as well as the core content elements that are to be identified during the process of atomization.

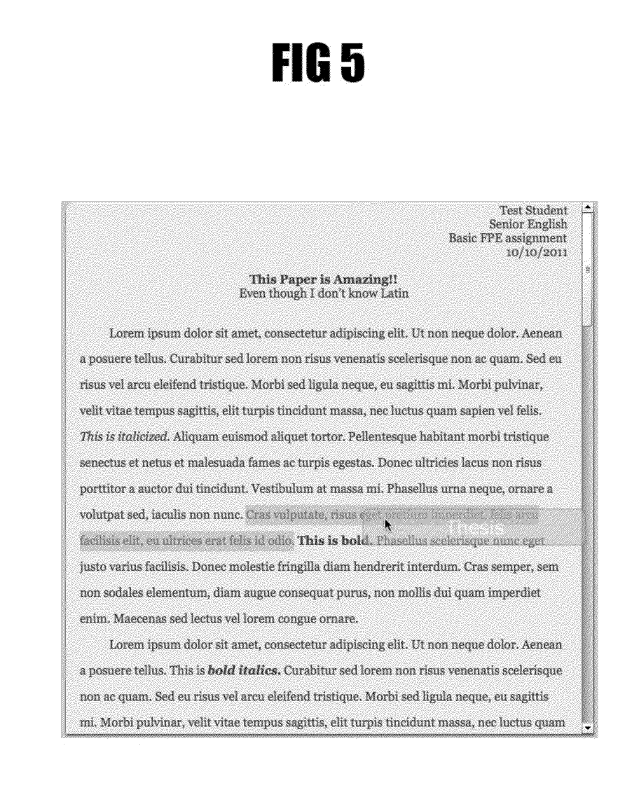

In this embodiment the reviewer then drags a core content element button over the document excerpt or text that the reviewer would like to associate with that core content element as shown in FIG. 5. This step in the process is the “atomization” wherein the reviewer atomizes the document into its constituent parts by identifying at least one document excerpt that corresponds to a particular core content element selected in the created rubric. The reviewer identifies the core content elements within the text and labels or “tags” them with the corresponding core content element selected in the created rubric. The text passage or document excerpt to be associated with the core content element is highlighted to indicate to the reviewer exactly which portion of the text or document excerpt will be associated. Skilled artisans will understand that there are a wide variety of other methods to atomize a document and identify which portions of the document are to be associated with a core content element.

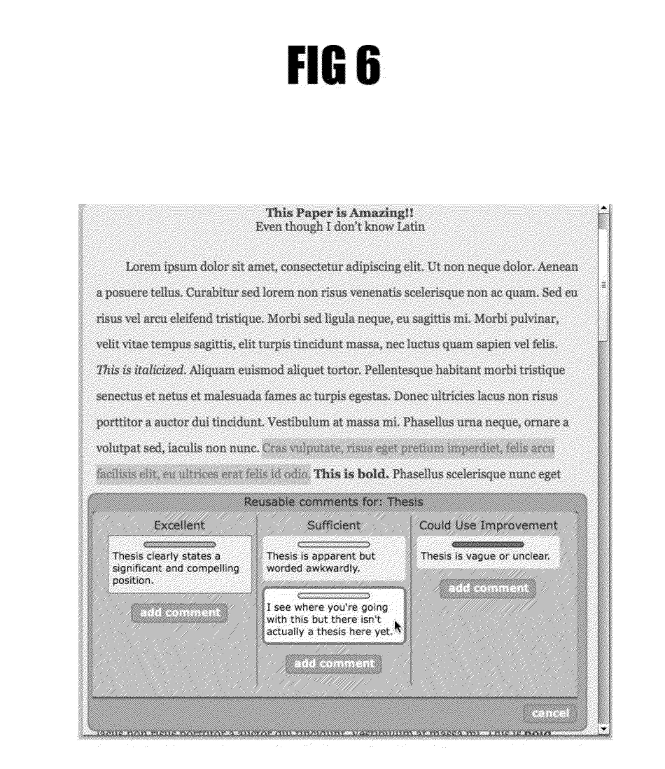

Once the passage is atomized into a core content element, the reviewer must evaluate the quality of that core content element as shown in FIG. 6. In this embodiment the possible quality levels that were created in the rubric are displayed across the top of the grid with the optional descriptive comments or feedback listed in columns underneath each quality level. The reviewer then selects the appropriate comment or feedback from the appropriate quality level column. In a preferred embodiment, the system provides the reviewer with the ability to create additional comments to be associated with a core content element.

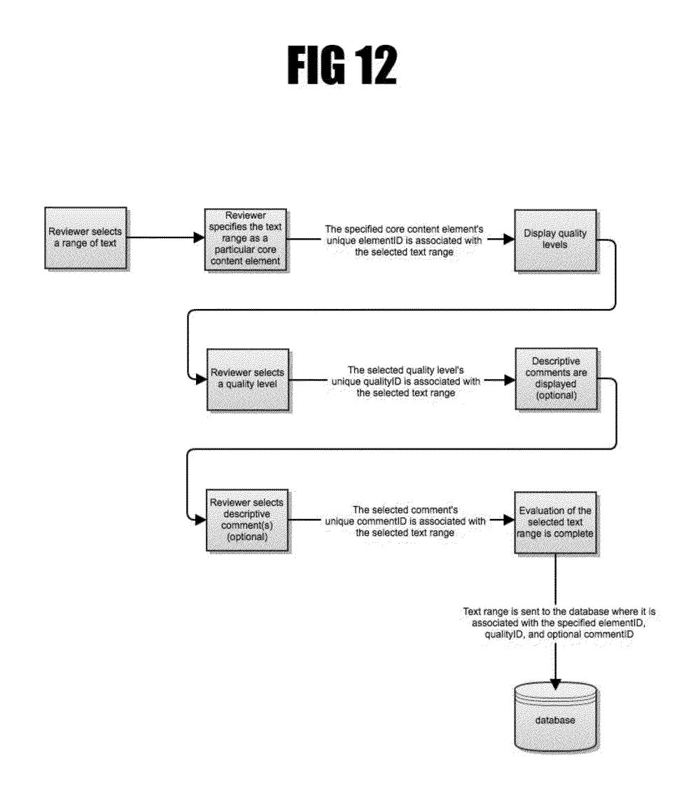

The atomized section of the document, its associated core content element designation, and its specified quality level and optional comment or feedback are stored in the database as shown in FIG. 12.

The reviewer continues to atomize and evaluate the document until all core content elements have been identified or the end of the document is reached. In some instances, core content elements can appear more than once in a document. For example, the “Body Paragraph” core content element would be used three times to identify, atomize, and evaluate the three body paragraphs found in a typical five-paragraph essay.

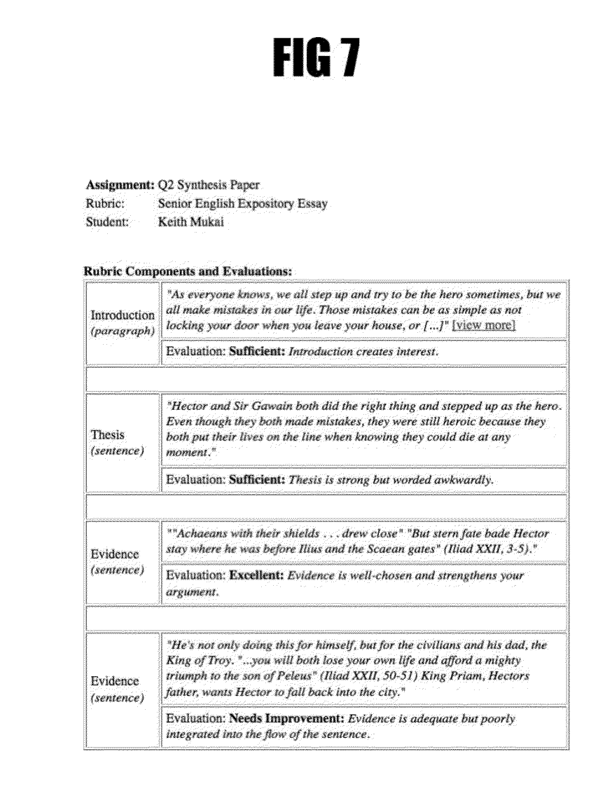

In one embodiment, the atomized and evaluated document can then be viewed in its atomized form as shown in FIG. 7. This view of the document reduces it down to just its core content elements and the reviewer's evaluations of each core content element's quality level. The document's associated assignment, evaluation rubric, and student are displayed. A listing of each core content element, the atomized text passage, and the specified quality level are also displayed. Optional descriptive comments or feedback are also displayed.

The review and evaluation stages of the present invention can be understood by the steps illustrated in FIG. 12. The reviewer first selects a range of text and associates the selected range of text with a specific core content element. The specified core content element possesses a unique element identifier and such unique element identifier becomes associated with the selected document excerpt to be stored in the database. The possible quality levels are then displayed and once the reviewer selects the quality level, the unique quality identifier of the selected quality level becomes associated with the selected document excerpt to be stored in the database. The system then provides the user with the option for further selecting possible descriptive comments to be associated with the selected document excerpt. The unique comment identifier of the selected comment becomes associated with the selected document excerpt to be stored in the database. The selected document excerpt along with the corresponding unique core content element identifier, quality identifier, and optional comment identifier are sent to the database for storage.

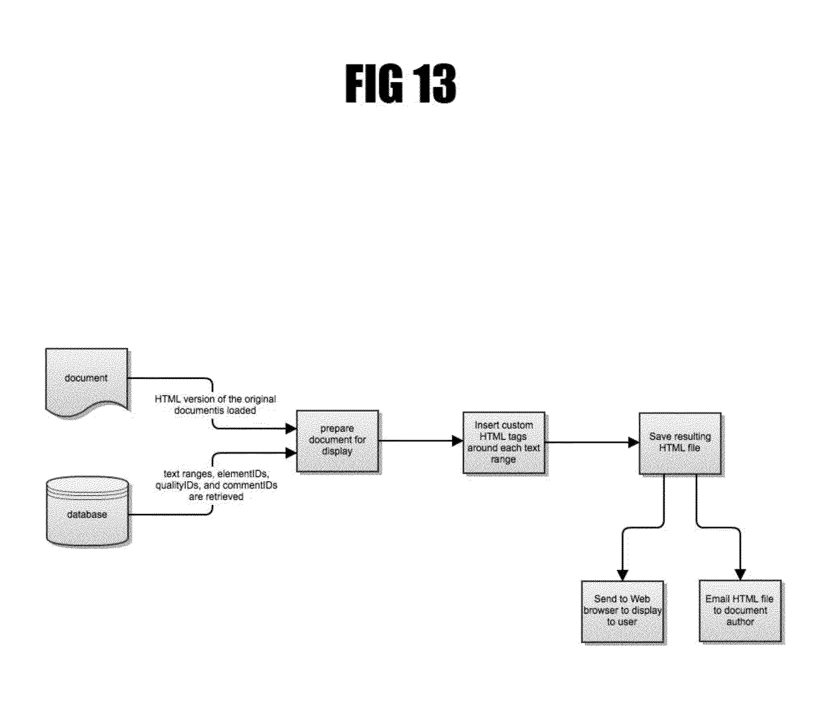

Once the evaluation of a document is complete, the reviewer may retrieve the document as shown in FIG. 13. In one embodiment, the system may upload an HTML version of the original document and the selected document excerpt along with the corresponding unique core content element identifier, quality identifier, and optional comment identifier for display to the user. Custom HTML tags are inserted around each selected document excerpt and such resulting document is saved. The resulting document may then be either sent to the web browser for display to user or emailed to the user, or in any other manner configured by the user.

In one embodiment, the present invention provides for the retrieval of exemplars of particular quality level evaluations for particular core content elements. Once the reviewer has defined the core content elements of a set of documents and evaluated such documents, the system can retrieve a random sample of such core content elements. For example, the system can retrieve “Thesis” elements that were evaluated as being “Excellent” and produce the associated document excerpt of each element. Such systems and methods find use for writing workshops in education, retrieval of key findings in legal rulings, and many other such uses.

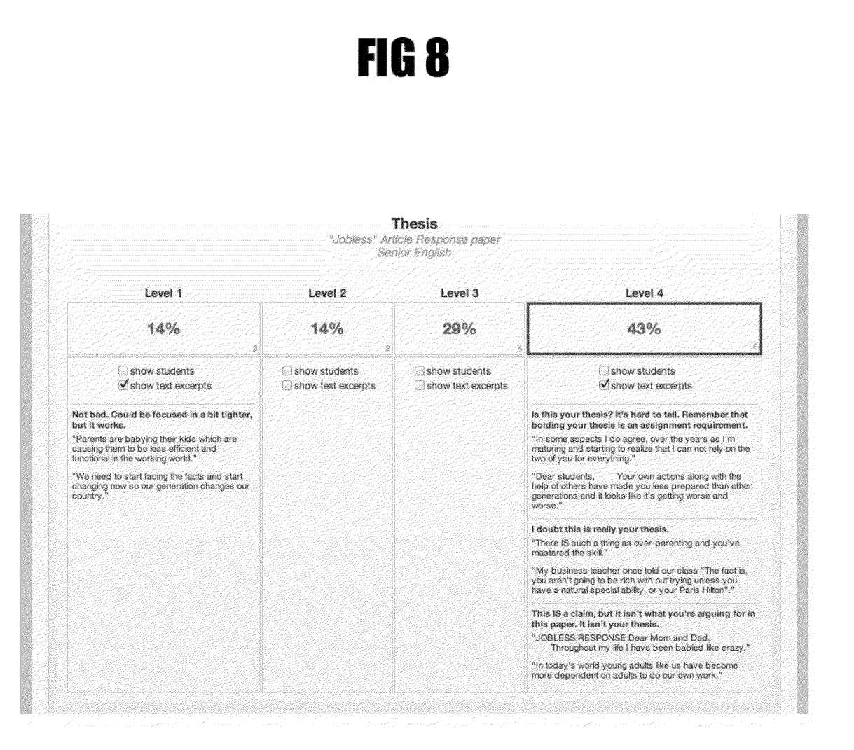

Once all documents from a particular assignment are atomized and evaluated, the system may generate a report on the aggregate quality of the document collection as a whole as shown in FIG. 8. The associated assignment is listed as well as the rubric used for evaluation. The grid of core content elements and possible quality levels is displayed. At each grid location the incidence of each core content element and possible quality level combination is calculated and displayed. Such reports are extremely valuable in diagnosing and focusing instruction on the class' areas of weakness. Skilled artisans will understand that a wide variety of other aggregate document collection analyses can be performed once documents in a collection have been atomized and evaluated.

Further data reporting and analysis can be provided by looking at the aggregate results of a particular core content element, as show in FIG. 8. A single core content element is displayed along with its corresponding aggregate results. The atomized document excerpts can be retrieved and are organized under their corresponding quality levels. In this example shown in FIG. 8, the document excerpts are further organized by the reviewer's selected feedback comments (shown in bold).

The present invention provides for the analysis of the structured evaluation data for multiple documents over time. For example, the system can chart the progression of a student's “Thesis” quality level evaluations across multiple assignments.

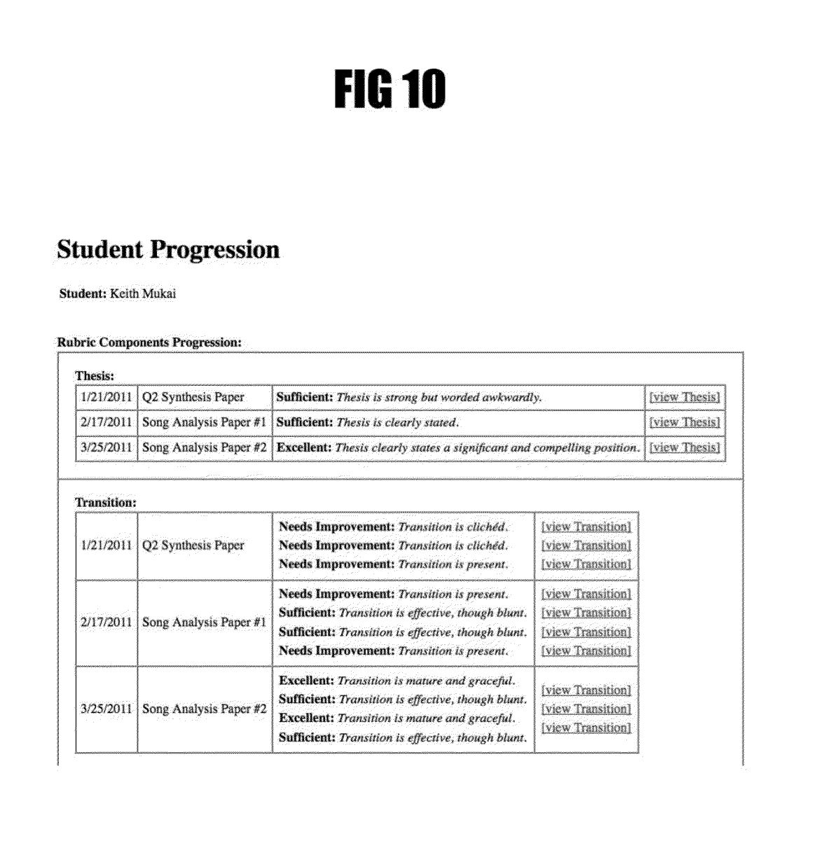

If the same rubric is used for multiple subsequent assignments, the progression of individual students' skills can be tracked over time as shown in FIG. 10. The student's name is listed and along with each core content element from the rubric. Each assignment is listed under each core content element. The student's quality level evaluations for each core content element is listed for each assignment. The actual atomized text passage for that core content element can be retrieved, if desired. When a particular core content element can be appear multiple times in an essay, each atomized instance will be listed. Skilled artisans will understand that there is a wide variety of other methods for displaying such progression data based on the atomization and evaluation methods provided for in the present invention.

The present invention provides for the analysis of multiple document collections in aggregate and as a progression over time. For example, the system can calculate the average rating of all students' “Thesis” core content element for a particular assignment. Further, the progression of an entire class' average “Thesis” quality level can be charted over the course of multiple assignments.

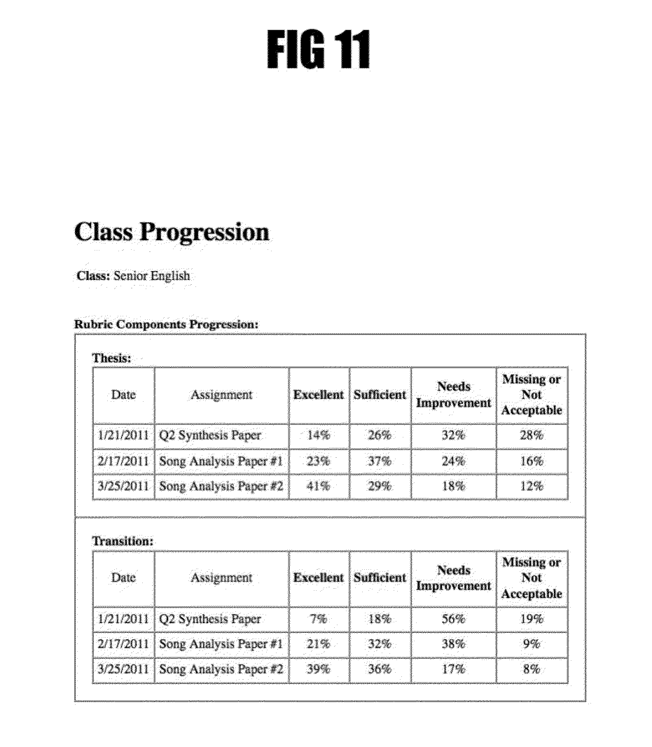

If the same rubric is used for multiple subsequent assignments, the progression of an entire class' skills can be tracked over time as shown in FIG. 11. The class' performance that is being analyzed is displayed along with each core content element. Within each core content element, each assignment is listed along with the distribution of evaluated quality levels for that core content element.

In one embodiment, the present invention provides the user with the ability to provide structured comments with the evaluations of each document excerpt. For example, specific feedback comments can be associated with specific quality level evaluations and stored alongside the document excerpt that they refer to. Such systems and methods find use for document review cycles, such as those found in education when providing feedback while grading essays, in law when revising briefs with junior attorneys, and many other such uses.

In some embodiments, the present invention provides systems and methods for refining the analysis and retrieval of evaluations when structured comments are used. For example, a “Thesis” element may be “Unsatisfactory” for many different reasons. The structured comments available within the “Unsatisfactory” quality level will allow for further differentiation of evaluation within that quality level. That higher degree of differentiation can then be analyzed and retrieved as needed. Such systems and methods find use for highly detailed document review cycles, such as those found in grading essays, reviewing legal briefs, and many other such uses.

As those skilled in the art will appreciate, other various modifications, extensions, and changes to the foregoing disclosed embodiments of the present invention are contemplated to be within the scope and spirit of the invention as defined in the following claims.

I hereby claim:

1. A system and method of evaluating, analyzing, and reviewing electronic documents comprising:
(a) Creating a rubric to evaluate at least one document by defining the at least one document in terms of at least one core content element to be reviewed and defining at least one quality level to be applied to each core content element that appears in the document;
(b) Storing said rubric in a database;
(c) Accessing a document to be reviewed;
(d) Displaying said document;
(e) Atomizing a document into its constituent parts or core content elements by identifying at least one document excerpt that corresponds to a core content element selected in step (a) above;
(f) Tagging or associating the at least one excerpt of the document with said core content element selected in step (a) above;
(g) Selecting a quality level from the at least one quality level for the at least one excerpt that is tagged to the core content element;
(h) Storing the at least one excerpt of the document, the associated or tagged core content element and the selected quality level into a database.

2. A system and method according to claim 1 wherein the rubric in step (a) is further created by identifying at least one comment to be included in the review of the document.

3. A system and method according to claim 2 wherein the at least one comment is selected specific to the at least one document excerpt, the associated or tagged core content element and the selected quality level.

4. A system and method according to claim 1 wherein the stored at least one excerpt of the document, the associated or tagged core content element and the selected quality level may be retrieved and displayed.

5. A system and method according to claim 4 wherein the stored at least one excerpt, the associated or tagged core content element and the selected quality level of multiple documents may be retrieved and pooled to display an aggregate evaluation of multiple documents.

6. A system and method according to claim 1 wherein the occurrence of a selected quality level in step (g) is quantified over time to provide a statistical analysis of the at least one document.

7. A system and method according to claim 2 wherein the occurrence of a selected comment is quantified over time to provide a statistical analysis of the at least one document.

8. A system and method according to claim 1 wherein the occurrence of a selected quality level in step (g) is quantified to provide a statistical analysis of the at least one document.

9. A system and method according to claim 1 wherein the occurrence of a selected quality level in step (g) of at least two documents is quantified to provide a statistical analysis of the at least two documents.

10. A system and method according to claim 1 wherein the occurrence of a selected quality level in step (g) of at least two document collections is quantified to provide a statistical analysis of the at least two document collections.

11. A system for evaluating, analyzing, and reviewing electronic documents comprising:
a computer or processor that is programmed to complete the following sequence of events:
(a) Creating a rubric to evaluate at least one document by defining the at least one document in terms of at least one core content element to be reviewed and defining at least one quality level to be applied to each core content element that appears in the document;
(b) Storing said rubric in a database;
(c) Accessing a document to be reviewed;
(d) Displaying said document;
(e) Atomizing a document into its constituent parts or core content elements by identifying at least one document excerpt that corresponds to a core content element selected in step (a) above;
(f) Tagging or associating the at least one excerpt of the document with said core content element selected in step (a) above;
(g) Selecting a quality level from the at least one quality level for the at least one excerpt that is tagged to the core content element;
(h) Storing the at least one excerpt of the document, the associated or tagged core content element and the selected quality level into a database.

12. A system according to claim 11 wherein the rubric in step (a) is further created by identifying at least one comment to be included in the review of the document.

13. A system according to claim 12 wherein the at least one comment is selected specific to the at least one document excerpt, the associated or tagged core content element and the selected quality level.

14. A system according to claim 11 wherein the stored at least one excerpt of the document, the associated or tagged core content element and the selected quality level may be retrieved and displayed.

15. A system according to claim 14 wherein the stored at least one excerpt, the associated or tagged core content element and the selected quality level of multiple documents may be retrieved and pooled to display an aggregate evaluation of multiple documents.

16. A system according to claim 11 wherein the occurrence of a selected quality level in step (g) is quantified over time to provide a statistical analysis of the at least one document.

17. A system according to claim 12 wherein the occurrence of a selected comment is quantified over time to provide a statistical analysis of the at least one document.

18. A system and method according to claim 11 wherein the occurrence of a selected quality level in step (g) is quantified to provide a statistical analysis of the at least one document.

19. A system and method according to claim 11 wherein the occurrence of a selected quality level in step (g) of at least two documents is quantified to provide a statistical analysis of the at least two documents.

20. A system and method according to claim 11 wherein the occurrence of a selected quality level in step (g) of at least two document collections is quantified to provide a statistical analysis of the at least two document collections.
